(19) United States
(12) Patent Application Publication
(10) Pub. No.: US 2020/0244147 A1
(43) Pub. Date: Jul. 30, 2020

(54) SINGLE-POLE ELECTROMAGNETICALLY-DRIVEN FOCUSING SYSTEM OF MICROMOTOR

(71) Applicant: YOVA TECHNOLOGY (HONG KONG) LIMITED, New Territories (HK)

(72) Inventors: Lin-Hsiang Ko, New Territories (HK); Xuyao Zhang, New Territories (HK); Chi-Lung Chang, New Territories (HK)

(21) Appl. No.: 16/261,529

(22) Filed: Jan. 29, 2019

(51) Int. Cl. H02K 11/215; H02K 41/035; G02B 7/04

(52) U.S. Cl. CPC H02K 11/215; H02K 2211/03; G02B 7/04; H02K 41/0356

(57) ABSTRACT

A micromotor single-pole electromagnetically-driven focusing system includes a slidable base having an outer end connectable to a camera lens; an elastic support system supporting the slidable base to maintain parallel movement; a coil circumferentially arranged around an outside of the slidable base and including a loop structure having four major sides; a circuit device including a circuit arrangement for control of a micromotor and arranged on a central location of one of the major sides of the coil and including a detection element and a sensing magnet; and two sets of single-pole magnet and the magnetism conducting yoke respectively arranged left and right major sides with respect to a center defined by the circuit device so that the two sets of single-pole magnet and magnetism conducting yoke and the circuit device form a U-shaped structure, with the two sets of single-pole magnet and magnetism conducting yoke opposite to each other.

### (a) TECHNICAL FIELD OF THE INVENTION

The present invention relates to a micromotor single-pole electromagnetically-driven focusing system, and more particularly to equipment that is widely applicable to miniature photographing devices of mobile phone camera systems to achieve the purposes of saving cost and reducing electromagnetic interference.

### (b) DESCRIPTION OF THE PRIOR ART

With photographing device becoming small and lightweight, techniques concerning micromotors become even more significant. Particularly, mobile phones are almost a must for daily living and the demand for micromotors that are used in mobile phones has reached the peak. Thus, techniques for improving micromotors are being in increasing progress and development.

Using the micromotors in photographing devices is for the purpose that the motor can fast, accurately, and stably achieve the desired purpose of focusing, and also for use in shaking preventing devices. Known techniques often adopt an advanced closed-loop arrangement of micromotors, shown in FIG. 10, wherein a movable base 70 (shown in phantom lines in the drawing) is fit, on the outside thereof, with a coil 80 that has four major sides. One of the major surfaces of the coil 80 is provided with a flexible circuit board 90. The flexible circuit board 90 is provided with a detection element 91, which allows for mutual detection with respect to a sensing magnet 92 arranged at an inner side of the coil 80 in order to detect a focusing position of the movable base 70. Power is supplied from a driving magnet 81, 82, 83, 84 arranged at each of the four major surfaces of the coil 80. When the coil 80 is fed with an electrical current, interaction with the driving magnets 81, 82, 83, 84 on the four sides to generate a Lorentz force, which, in combination with the operation of the detection element 91 and the sensing magnet 92 provided on the circuit board 90, enables the movable base 70 to carry out precise movement control.

However, for saving space, in such a structure, the positions where the detection element 91 and the sensing magnet 92 are assembled are provided at a corner of the coil 80 in order to collaboratively combine with the four driving magnets 81, 82, 83, 84 on the four sides to form a micromotor structure. Thus, the driving magnets 81, 82, 83, 84 around the coil 80 form an inclined symmetric arrangement and the four driving magnets 81, 82, 83, 84 may generate two sets of opposite magnetic forces to cause interference, such as the two magnetic force axis lines L1, L2 shown in the drawing. This also significantly affects the accuracy of the detection element 91 and the sensing magnet 92 (position detecting components), particularly variation of accuracy caused by change of posture. In the known electromagnetically-driven focusing systems, in using a camera or a mobile phone to take a picture, due to difference in respect of elevation angle, horizon, down angle of the camera lens (motor), related components, such as a linear motor illustrated in FIG. 9, to show displacement or stroke varying linearly with a digital-to-analog converter (DAC) of an electrical current flowing through the coil. FIG. 9 shows, for horizontal forward driving, a solid line is of a normal ratio, while when the camera lens (motor) is operated with an elevation angle or down angle, as shown in the upward driving and downward driving of FIG. 9, irregular variation occurs in the curves. One reason that is commonly seen is that the detection element 91, the sensing magnet 92, and the driving magnet 81, 82, 83, 84 that are shown in FIG. 10 may cause, due to magnetic attraction, interference with the driving of the slidable base 70, so that deviation occurs in upward driving, horizontal driving, and downward driving. Thus, the accuracy of transmission is deteriorated and focusing and shake prevent of a mobile phone may become unstable. This is the major drawback of the known techniques.

Considering the current technical level of the industry, where, as shown in FIG. 10, the slidable base 70 that carries the camera lens being of a cylindrical structure and the coil 80 being a frame having four major sides are almost invariant. The challenge of the industry to minimize the size but still maintain the accuracy of measurement at a predetermined level can only be achieved through ingenious and delicate arrangements.

In addition, the known techniques require four sensing magnets. In addition to interferences that they may cause with other components, they also create additional burden of weight. This is also an issue to be resolved.

### SUMMARY OF THE INVENTION

The primary objective of the present invention is to eliminate an arrangement that requires two sets of driving magnet so as to avoid mutual interference therebetween and also to avoid interference among the driving magnet and the detection element and the sensing magnet due to being closely located. As such, additional consideration may be taken in order to overcome such issues.

Another objective of the present invention is to eliminate the use of two sets of driving magnet, and, instead, using just on set of driving magnet but reducing the issue of electromagnetic interference due to ingenious and delicate position arrangement, so that even though one set of magnet is removed for reducing the weight, the force for driving the slidable base is not reduced, and accuracy of detection is improved.

Thus, single-pole magnets and magnetism conducting yokes can be set distant from the sensing magnet and the detection element that are provided for purposes of positioning so as to minimize the noise interference generated during detection to thereby effectively reduce signal variation caused by posture difference (facing upward or facing downward) to make focusing and detection for shake prevention more accurate and the weight reduced.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view showing a major structure of the present invention.

FIG. 2 is a perspective view showing the present invention mounted to a micromotor.

FIG. 3 is an exploded view showing a partial structure of the present invention.

FIG. 4 is another exploded view showing a partial structure of the present invention.

FIG. 5 is a schematic view illustrating a major structure of the present invention.

FIG. 6 is another schematic view illustrating a major structure of the present invention.

FIG. 7 is a cross-sectional view of the present invention.

FIG. 8 is a schematic view illustrating an arrangement of U-shaped structures of the present invention in a dual-lens application.

FIG. 9 is a plot illustrating an effect of interference on forward driving caused by magnetic attraction due to angular variation among components (such as a detection element, a sensing magnet, and a driving magnet) of an electromagnetically-driven focusing system.

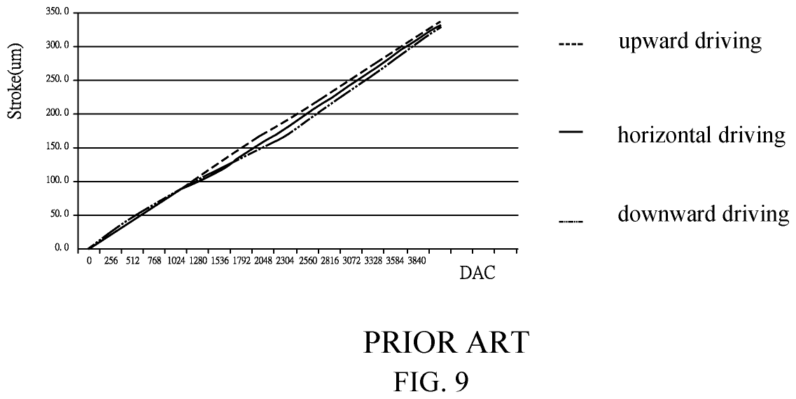

FIG. 10 is a schematic view showing a known structure.

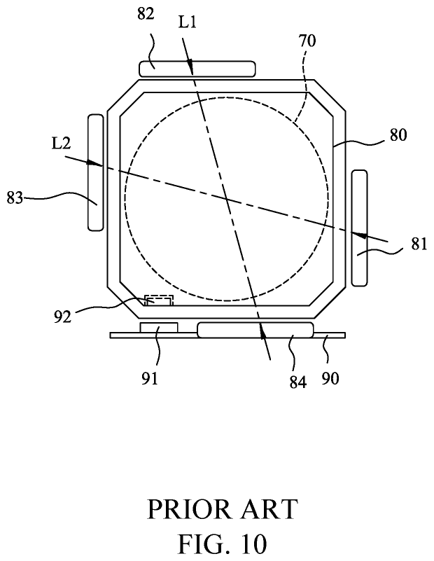

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

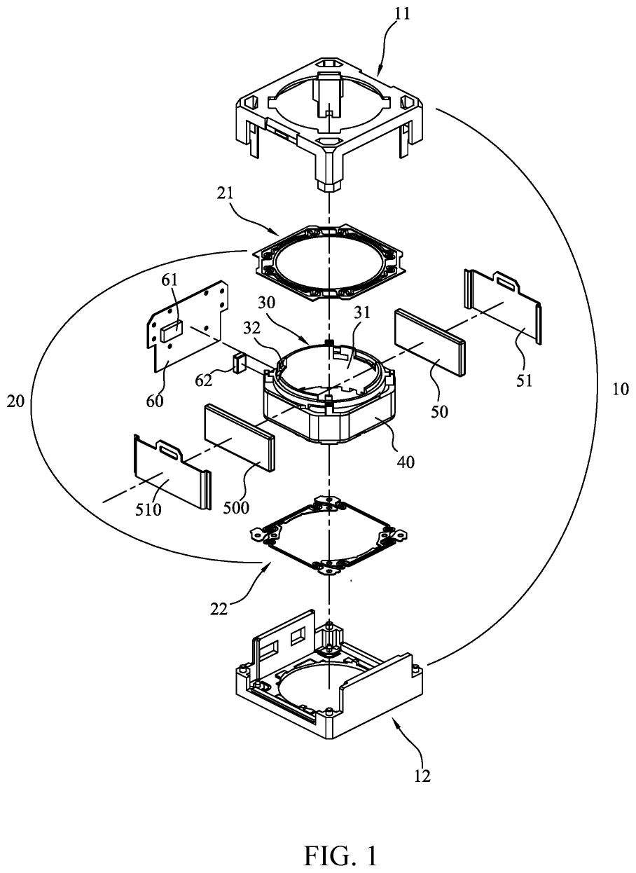

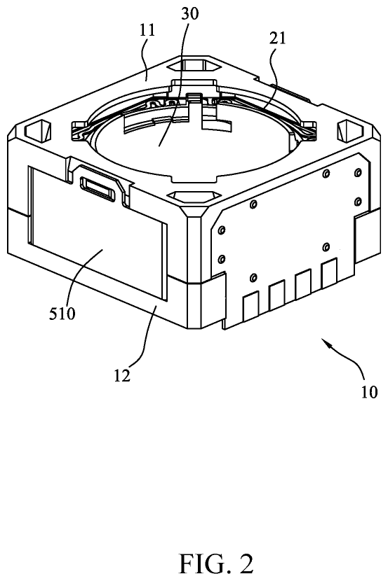

FIGS. 1 and 2, the present invention is provided for mounting between a frame 11 and a chassis 12 of a micromotor housing 10 and at least comprises the following components:

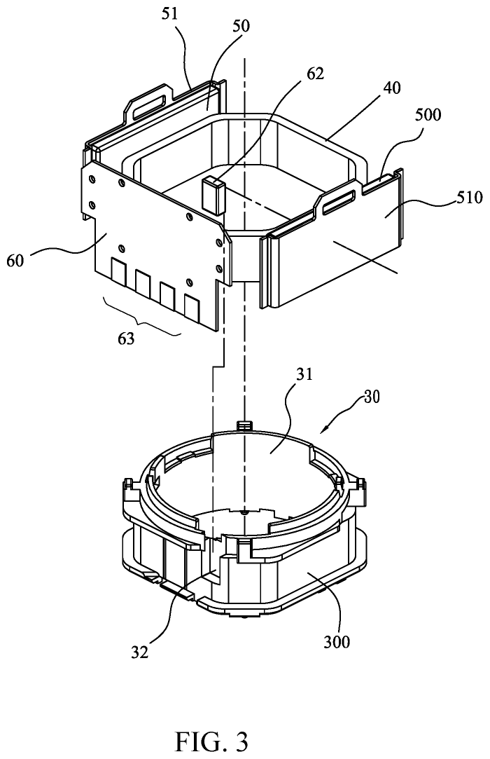

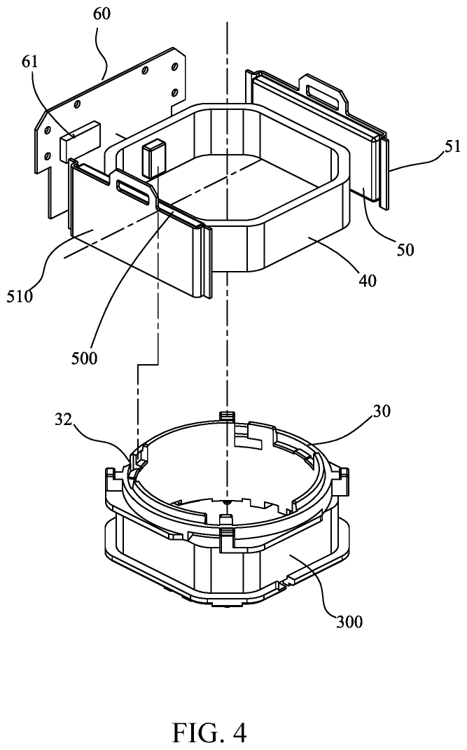

Referring to FIGS. 3, 4, and 7, a movable base 30 comprises a cylindrical structure having a center that is formed with a hollow passage 31 and is connectable with a camera lens with an outer end thereof, and is provided with a slide channel 32 at a location adjacent to the outer end, and is provided with a circumferential groove 300 formed in an external surface thereof.

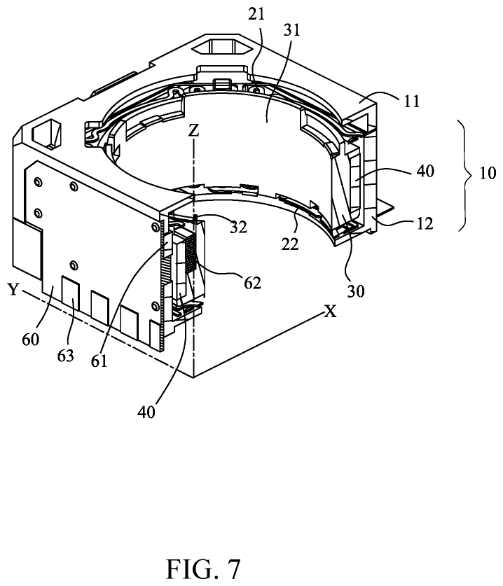

As shown in FIGS. 1 and 7, an elastic support system 20 comprises an upper spring plate 21 and a lower spring plate 22, which are respectively coupled to two opposite ends of the movable base 30.

Referring to FIGS. 1, 3, and 4, a coil 40 is circumferentially arranged around the circumferential groove 300 of the slidable base 30 and comprises a loop structure having four major sides.

Referring to FIGS. 1, 3, 4, and 7, a circuit device 60 comprises a circuit arrangement for control of a micromotor and is arranged on a central location of one of the major sides of the coil 40 to be receivable in an insertion slot between the frame 11 and the chassis 12, wherein the circuit device 60 has an inside surface that is provided with a detection element 61, and a sensing magnet 62 that corresponds to the detection element 61 being arranged in the slide channel 32 of the movable base 30 to be spaced from and opposite to each other with respect to the coil 40; and the circuit device 60 has an outside surface that is provided with a plurality of contact terminals 63 connectable with power and signal signals wires.

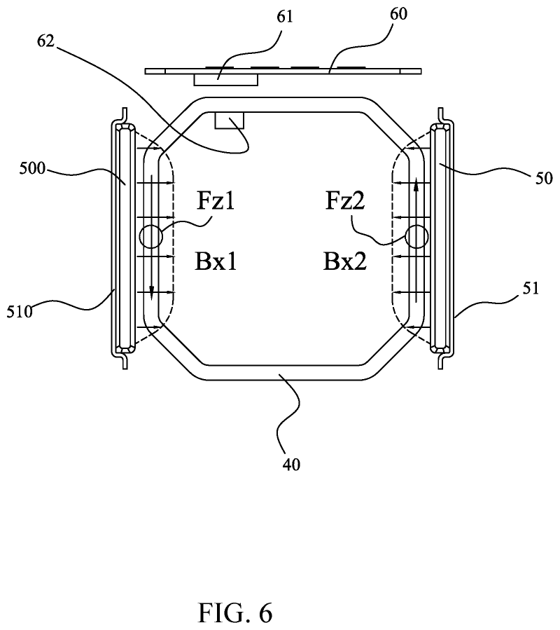

Two single-pole magnets 50, 500 are respectively provided, on an outer side thereof, with magnetism conducting yokes 51, 510 to form assemblies that are respectively arranged on outside of two of the major sides of the coil 40 at left and right with respect to a center defined by the circuit device 60, so that an outer periphery of the coil 40 is formed as a U-shaped structure (see FIG. 6) by means of the assembly of the single-pole magnet 50 and the magnetism conducting yoke 51, the circuit device 60, and the assembly of the single-pole magnet 500 and the magnetism conducting yoke 510, wherein the two single-pole magnets 50, 500 together with the magnetism conducting yokes 51, 510 are arranged opposite to each other with respect to the coil 40, so as to face each other.

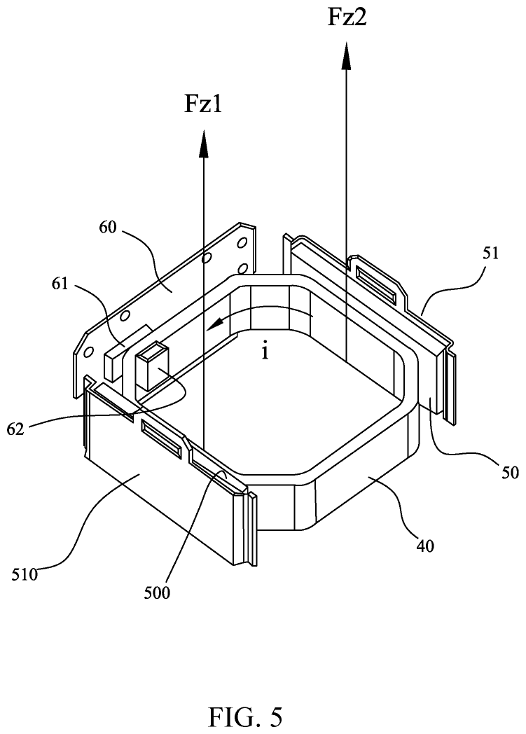

Referring to FIGS. 5 and 6, the primary operation of the present invention is that two single-pole magnets 50, 500 together with the magnetism conducting yokes 51, 510 thereof are arranged opposite to and corresponding to each other with respect to the front side of the coil 40, so that under the condition that directions of magnetic fields BX1, BX2 of the two single-pole magnets 50, 500 (as shown in FIG. 6) are respectively in a positive direction (rightward) and a negative direction (leftward), with the coil 40 being immersed in the two magnetic fields BX1, BX2, as shown in FIG. 5, when the coil 40 is supplied with an electrical current i, according to Lorentz law, magnetic forces FZ1, FZ2 are generated and are perpendicular to the two single-pole magnets 50, 500 and the two magnetic forces FZ1, FZ2 are of identical magnitudes. Thus, when the magnitude of the current i of the coil 40 changes, the sensing magnet 62 is caused to move along a Z-axis (shown in FIGS. 5 and 7) and meanwhile, the detection element 61 detects accurately a movement amount of the slidable base 30 in order to carry out an optical measurement operation, such as focusing.

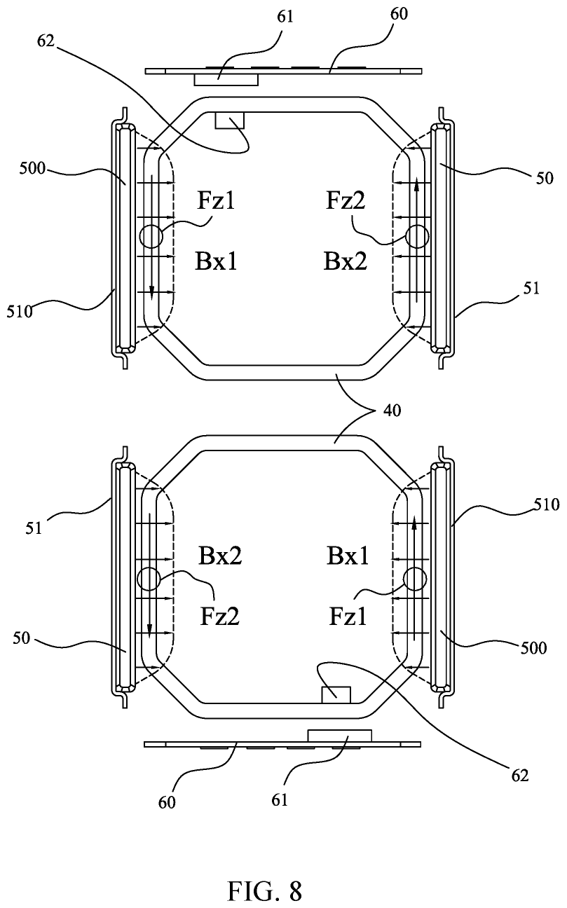

In an application of a dual-lens camera device, the present invention provides unique advantages, where primarily, two structures of the present invention as described above are disposed, collectively, in the dual-lens camera device in a manner demonstrated in FIG. 8. The two present inventive structures are both formed of two single-pole magnets 50, 500 in combination with the magnetism conducting yokes 51, 510 arranged on outer sides thereof to form assemblies that are arranged on two of the major sides of the coil 40 at left and right with respect to a center defined by the circuit device 60 so that the outer periphery of the coil 40 is formed as a U-shaped structure by means of the assembly of the single-pole magnet 50 and the magnetism conducting yoke 51, the circuit device 60, and the assembly of the single-pole magnet 500 and the magnetism conducting yoke 510, wherein the two single-pole magnets 50, 500 together with the magnetism conducting yokes 51, 510 are arranged opposite to and corresponding to each other with respect to the coil 40 so as to face each other. The two U-shaped structures are arranged side by side to form an elongated body and the circuit devices 60 of the two structures are located at two outermost ends to be opposite to each other and the single-pole magnets 50, 500 to which the magnetism conducting yokes 51, 510 are combined are arranged, in a pairwise manner, at two opposite sides of the coils 40.

The unique structural arrangement of the present invention provides the following advantages:

(1) The present invention comprises a coil of which a periphery has four major sides, wherein with the circuit device as a reference, two of the major sides of the periphery of the coil, which are respectively at right and left with respect to the circuit device, are each provided with a single-pole magnet and a magnetism conducting yoke, so that the outer periphery of the coil is formed as a U-shaped structure by means of a combination of a single-pole magnet and a magnetism conducting yoke, a circuit device, and a combination of a single-pole magnet and a magnetism conducting yoke, wherein in such an arrangement, the single-pole magnets and the magnetism conducting yokes are bot distant from a sensing magnet and a detection element that are provided for positioning purposes so as to minimize noise inference generated in making detection and thus effectively preventing signal variation caused by posture difference (such as facing upward or facing downward) to thereby making focusing and shake-prevention detection more accurate. This is the major advantage of the present invention.

(2) In an application of the present invention to a dual-lens camera device, two U-shaped structures are used as a system, wherein although two motors may be arranged together, due to the structural arrangement of the U-shaped structures, they can be set at an extremely short distance with each other, but the two circuit devices are still far apart so that there is no magnetic attraction or magnetic repulsion (wherein the arrangement of positioning is shown in FIG. 8). This is also an advantage of the U-shaped structure of the present invention.

(3) Compared to the known structure, the present invention has a weigh that is lessened by the weights of two single-pole magnets so that the size is even smaller and thinner, but no delaying caused by reduction of magnets may occur in driving the slidable base and would support sufficient driving power, and cost is reduced. This is another advantage of this invention.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A micromotor single-pole electromagnetically-driven focusing system, which is mounted between a frame and a chassis of a micromotor housing, at least comprising:
a movable base, comprises a cylindrical structure having a center that is formed with a hollow passage and is connectable with a camera lens with an outer end thereof, and is provided with a slide channel at a location adjacent to the outer end, and is provided with a circumferential groove formed in an external surface thereof;
an elastic support system, which comprises an upper spring plate and a lower spring plate, which are respectively coupled to two opposite ends of the movable base;
a coil, which is arranged circumferentially around an outside of the slidable base and comprises a loop structure having four major sides;
a circuit device, which comprises a circuit arrangement for control of a micromotor and is arranged on a central location of one of the major sides of the coil, the flexible circuit board having an inside surface that is provided with a detection element, with a sensing magnet corresponding to the detection element and arranged in the slide channel of the movable base so as to be spaced from and opposite to each other with respect to the coil; and
two single-pole magnets, which are respectively provided, on an outer side thereof, with magnetism conducting yokes to form assemblies that are respectively arranged on outside of two of the major sides of the coil at left and right with respect to a center defined by the circuit device, so that an outer periphery of the coil is formed as a U-shaped structure by means of the assembly of one of the single-pole magnets and the magnetism conducting yoke corresponding thereto, the circuit device, and the assembly of another one of the single-pole magnets and the magnetism conducting yoke corresponding thereto, wherein the two single-pole magnets together with the magnetism conducting yokes are arranged opposite to each other with respect to the coil, so as to face each other.

2. The micromotor single-pole electromagnetically-driven focusing system according to claim 1, wherein the circuit device is received in an insertion slot between the frame and the chassis.

3. The micromotor single-pole electromagnetically-driven focusing system according to claim 1, wherein the circuit device has an outside surface that is provided with a plurality of contact terminals connectable to power and signal lines.

4. The micromotor single-pole electromagnetically-driven focusing system according to claim 1, wherein the movable base is formed with a circumferential groove in an external surface and the coil is looped around the circumferential groove.

5. A micromotor single-pole electromagnetically-driven focusing system, which is adapted to mount in a dual-lens camera device and comprises two systems, each of the two system at least comprising a frame and a chassis of a micromotor housing and further comprising, arranged between the frame and the chassis:
a movable base, comprises a cylindrical structure having a center that is formed with a hollow passage and is connectable with a camera lens with an outer end thereof, and is provided with a slide channel at a location adjacent to the outer end, and is provided with a circumferential groove formed in an external surface thereof;
an elastic support system, which comprises an upper spring plate and a lower spring plate, which are respectively coupled to two opposite ends of the movable base;
a coil, which is arranged circumferentially around an outside of the slidable base and comprises a loop structure having four major sides;
a circuit device, which comprises a circuit arrangement for control of a micromotor and is arranged on a central location of one of the major sides of the coil, the flexible circuit board having an inside surface that is provided with a detection element, with a sensing magnet corresponding to the detection element and arranged in the slide channel of the movable base so as to be spaced from and opposite to each other with respect to the coil; and
two single-pole magnets, which are respectively provided, on an outer side thereof, with magnetism conducting yokes to form assemblies that are respectively arranged on outside of two of the major sides of the coil at left and right with respect to a center defined by the circuit device, so that an outer periphery of the coil is formed as a U-shaped structure by means of the assembly of one of the single-pole magnets and the magnetism conducting yoke corresponding thereto, the circuit device, and the assembly of another one of the single-pole magnets and the magnetism conducting yoke corresponding thereto, wherein the two single-pole magnets together with the magnetism conducting yokes are arranged opposite to each other with respect to the coil, so as to face each other;
wherein the U-shaped structures of the two systems are arranged side by side to form an elongate body, the two circuit devices being arranged at outermost ends to be opposite to each other, the single-pole magnets to which the magnetism conducting yokes are combined being arranged, in a pairwise manner, at two opposite sides of the coil.
